(19) United States
(12) Patent Application Publication
(10) Pub. No.: US 2004/0249922 A1
(43) Pub. Date: Dec. 9, 2004

(54) Home automation system security

(76) Inventors: Thomas J. Hackman, Florence, KY (US); Christopher A. Powell, Taylor Mill, KY (US)

Correspondence Address: TAFT, STETTINIUS & HOLLISTER LLP, SUITE 1800, 425 WALNUT STREET, CINCINNATI, OH, 45202-3957, US

(21) Appl. No.: 10/813,916

(22) Filed: Mar. 31, 2004

Related U.S. Application Data
(60) Provisional application No. 60/459,206, filed on Mar. 31, 2003.

(51) Int. Cl. G06F 15/173; H04L 12/66; G06F 15/16; H04L 9/32

(52) U.S. Cl. 709/223; 709/229; 713/200

(57) ABSTRACT

A computer network controlled/monitored automation system for a residence (such as a home, a business, an office, etc.) in which a residential server controls and monitors security and other computer controllable systems within the residence. To provide maximum security, the residential server is configured to deny any inbound connections. The residential server initiates a secure connection to a central system controller's server so that the residential server can receive commands and other communications from the central system controller's server, some of which may have been communicated to the central system controller's server by an authorized remote user/occupant of the residence over the Internet.

### CROSS-REFERENCE TO RELATED APPLICATION

This application claims the benefit of U.S. Provisional Application Serial No. 60/459,206 entitled “HOME AUTOMATION SYSTEM SECURITY” filed on Mar. 31, 2003.

### BACKGROUND

1. Field of the Invention

The present invention is related to home automation systems; and more particularly, a system and method for solving many Internet security problems encountered by prior-art home automation systems.

2. Background of the Invention

FIG. 1 illustrates a network overview of a current industry standard for Web control of a home automation system. Such prior-art home automation systems place a Web server in each of the homes that remote users can directly connect to outside of the home, such as, for example, via a laptop while traveling or via a PC while at work. To access the user's home automation system, the remote user simply ‘surfs’ directly to a Web server that is located in the home. This Web server is usually directly connected to the Internet and very exposed to hackers. For example, the data connections shown in FIG. 1 are all established via plain text HTTP requests (unencrypted). A primary disadvantage with this prior-art system is that a Web server directly connected to the Internet is often exposed to hackers. If proper precautions are taken, the risk to someone hacking into the home can be minimized but not eliminated. The home is an attractive target to hackers for many obvious reasons. The most common vulnerabilities to the systems that are sought after are flaws in the operating system, Web server or ancillary services. Operating system manufacturers are constantly releasing patches to repair recently discovered security flaws or to stop newly invented hacking tools. Corporations usually have someone on their IT staff actively monitoring their servers, installing all of the latest security patches, and reacting to stop intrusions. Homeowners, on the other hand, will unlikely have the technical background to perform this task, and a system initially intended to make their life easier should not place this type of burden upon them.

In such a traditional home automation scheme, each home has its own independent Web server as discussed above. The hacker could work unnoticed against individual home Web server and the intrusion would likely go unnoticed for the initial few homes. After a successful intrusion method has been developed, hackers could go after a large number of homes unobserved because the traditional scheme lacks central monitoring. To halt intrusions, and to repair the breach, every home server would have to be turned off and patched with the latest security and protection codes. Furthermore, hacking usually requires quite a bit of research and trial and error on the part of the hacker. When homes have servers that are publicly accessible on the Internet, a hacker can unobtrusively gather data about the home server's vulnerabilities and how it operates. They then usually try many different approaches in search of one that might be fruitful. Without central monitoring, this trial and error hacking method could go unnoticed for long periods of time.

FIG. 2 provides a flow chart illustration indicating a prior-art authentication process for user connecting to their home Web server. As shown in the first step 20, a user on the Internet connects to the Web server in the home using their Web browser. This is a direct TCP/IP connection on port 80. At this point, the user may be a valid user or a hacker. Everybody on the public Internet can connect to this computer. This exposes the home Web server to many exploits if the latest security patches are not applied. The home Web server is also directly exposed to many Internet worms and viruses. In the next step 22 shown in FIG. 2, the server in the home responds with a log-in Web page for the user to authenticate. As shown in the next step 24, the user enters their user name and password; both of which are sent in plain text over the Internet to the server in the home. At this point a hacker could capture the user name and password using one of many different types of data capturing techniques. With this, they could later log-on as a “valid” user. As shown in the next step 26, if the home Web server determines the user name and password to be valid then the process continues on to the final step 28. Otherwise, the process returns to the step 22 requesting the user to enter his or her user name and password. In this recursive process, the hacker could use a brute force or dictionary attack to keep attempting passwords until they succeed. If the home locks out that IP, they can attack other homes in the meantime and come back the next day to resume the attack. In the final step 28 shown in FIG. 2, the Web server in the home responds with the Web page that allows the user to control their home. At this point, the hacker could intercept the transmissions and possibly impersonate transmissions from the user.

### SUMMARY OF THE INVENTION

The present invention provides a computer network controlled/monitored automation system for a residence (such as a home, a business, an office, etc.) in which a residential server (located in or associated with the residence) controls and monitors security and other computer controllable systems within the residence. The residential server of the present invention is configured to deny any inbound connections or requests over the Internet (or over whatever alternative communication/data network that it is coupled to). Further, the residential server is configured to initiate a connection to a central system controller's server (or server farm) so that the residential server can receive commands and other communications from the central system controller's server, some of which may have been communicated to the central system controller's server by an authorized remote user/occupant of the residence over the Internet.

Accordingly, it is a first aspect of the present invention to provide a computerized residential automation system that includes: (a) a central system controller server operatively coupled to a data network; and (b) a residential automation computer system, operatively coupled to the data network, where the residential automation computer system is associated with a residence and configured to handle one or more residential automation functions. The residential automation computer system is configured to deny all inbound data connections from the data network, and the residential automation computer system is further configured to initiate a connection with the central system controller for communicating residential automation information between the central system controller and the residential automation computer system. In a more detailed embodiment, the connection with the central system controller is a secure connection. In an even more detailed embodiment, the connection with the central system controller is a maintained secure connection. In an even more detailed embodiment, the maintained secure connection is periodically renegotiated.

In an alternate detailed embodiment of the first aspect of the present invention, the secure connection utilizes encryption algorithms for communications between the residential automation computer system and the central system controller.

In another alternate detailed embodiment of the first aspect of the present invention, the secure connection utilizes public/private key pair techniques for communications between the residential automation computer system and the central system controller.

In another alternate detailed embodiment of the first aspect of the present invention, the central system controller includes a plurality of central system control computers in a server farm.

In another alternate detailed embodiment of the first aspect of the present invention, the central system controller includes a plurality of central system control computers, each central system control computer being associated with a specific geographic region.

In another alternate detailed embodiment of the first aspect of the present invention, the central system controller is configured to accept inbound connections from a remote computer operatively coupled to the data network. In a more detailed embodiment, the central system controller includes an authentication algorithm for controlling access to the central system controller to an authorized user of the remote computer. In an even more detailed embodiment, the central system controller monitors for unauthorized access from the remote computer.

In another alternate detailed embodiment of the first aspect of the present invention, the data network is a global computer network. In a more detailed embodiment, the global computer network is the World-Wide-Web. In an even more detailed embodiment, the central system controller provides an access Web site on the World-Wide-Web that is configured to accept Web access from a remote computer operatively coupled to the World-Wide-Web. In an even more detailed embodiment, the access Web site is password protected for controlling access to the central system controller to authorized users. In another even more detailed embodiment, the access Web site is configured to allow an authorized user of the remote computer to communicate with the residential automation computer system, wherein communications between the remote computer and the residential automation computer system are transferred over the connection initiated with the central system controller by the residential automation computer system. In yet a further detailed embodiment, the communications between the remote computer and the residential automation computer system are indirect communications that are processed by the central system server.

In another alternate detailed embodiment of the first aspect of the present invention, the computerized residential automation system also includes a firewall operatively coupled between the data network and the residential automation computer system, where the firewall prevents inbound data connections to the residential automation computer system from the data network. In a more detailed embodiment, the firewall is a hardware component separate from the residential automation computer system.

It is a second aspect of the present invention to provide a computerized residential automation system that includes: (a) a central system controller server operatively coupled to a data network; (b) a residential automation computer system associated with a residence and configured to handle one or more residential automation functions; and (c) a firewall operatively coupling the residential automation computer system to the data network and being configured to deny all inbound data connections from the data network to the residential computer. In a more detailed embodiment, the residential automation computer system is further configured to initiate a connection with the central system controller over the data network for communicating residential automation information between the central system controller and the residential automation computer system. In an even more detailed embodiment, the connection is a secure connection utilizing encryption algorithms for communications between the residential automation computer system and the central system controller.

In an alternate detailed embodiment of the second aspect of the present invention, communication between the residential automation computer system and the central system controller occurs over a maintained secure connection on the data network. In a more detailed embodiment, the maintained secure connection on the data network is initiated by at least one of the residential automation computer system and the firewall. In another more detailed embodiment, the maintained secure connection is periodically renegotiated. In yet another more detailed embodiment, the maintained secure connection utilizes encryption algorithms for communications between the residential automation computer system and the central system controller.

In another alternate detailed embodiment of the second aspect of the present invention, the central system controller includes a plurality of central system control computers in a server farm.

In another alternate detailed embodiment of the second aspect of the present invention, the central system controller includes a plurality of central system controller computers, each central system controller computer being associated with a specific geographic region.

In another alternate detailed embodiment of the second aspect of the present invention, the central system controller is configured to accept inbound connections from a remote computer operatively coupled to the data network. In a more detailed embodiment, the central system controller includes an authentication algorithm for controlling access to the central system controller to authorized users of the remote computer. In an even more detailed embodiment, the central system controller monitors for unauthorized access from the remote computer.

In another alternate detailed embodiment of the second aspect of the present invention, the data network is a global computer network. In a more detailed embodiment, global computer network is the World-Wide-Web. In an even more detailed embodiment, the central system controller provides an access Web site on the World-Wide-Web that is configured to accept Web access from a remote computer operatively coupled to the World-Wide-Web. In an even more detailed embodiment, the access Web site is password protected for controlling access to the central system controller to authorized users. In another even more detailed embodiment, the access Web site is configured to allow an authorized user of the remote computer to communicate with the residential automation computer system, where communications between the remote computer and the residential automation computer system are transferred over a maintained connection between the central system controller and at least one of the residential automation computer system and the firewall. In another even more detailed embodiment, the access Web site is configured to allow an authorized user of the remote computer to communicate with the residential automation computer system, wherein communications between the remote computer and the residential automation computer system are transferred over a connection initiated with the central system controller by the residential automation computer system and/or the firewall. In yet an even more detailed embodiment, the communications between the remote computer and the residential automation computer system are indirect communications that are processed by the central system server.

It is a third aspect of the present invention to provide a computerized residential automation system that includes: (a) a central system controller server operatively coupled to a data network; and (b) a residential automation computer system, operatively coupled to the data network, where the residential automation computer system is associated with a residence and configured to handle one or more residential automation functions. The residential automation computer system is configured to deny all inbound data connections from the data network, and the residential automation computer system is connected with the central system controller over the data network by a maintained secure connection. In a more detailed embodiment, the maintained secure connection is initiated by the residential automation computer system.

In alternate detailed embodiment of the third aspect of the present invention, the maintained secure connection is periodically renegotiated.

In another alternate detailed embodiment of the third aspect of the present invention, the central system controller is configured to accept inbound connections from a remote computer operatively coupled to the data network. In a more detailed embodiment, the central system controller includes an authentication algorithm for controlling access to the central system controller to authorized users of the remote computer. In an even more detailed embodiment, the central system controller monitors for unauthorized access from the remote computer. In another even more detailed embodiment, the data network is a global computer network. In yet an even more detailed embodiment, the global computer network is the World-Wide-Web. In yet an even more detailed embodiment, the central system controller provides an access Web site on the World-Wide-Web that is configured to accept Web access from a remote computer operatively coupled to the World-Wide-Web. In yet an even more detailed embodiment, the access Web site is password protected for controlling access to the central system controller to authorized users. In an alternate further detailed embodiment, the access Web site is configured to allow an authorized user of the remote computer to communicate with the residential automation computer system, where communications between the remote computer and the residential automation computer system are transferred over the maintained secure connection. In yet an even more detailed embodiment, the communications between the remote computer and the residential automation computer system are indirect communications that are processed by the central system server.

It is a fourth aspect of the present invention to provide a computerized residential automation system that includes: (a) a central system controller server operatively coupled to a data network; (b) a residential automation computer system, operatively coupled to the data network, where the residential automation computer system is associated with a residence and configured to handle one or more residential automation functions; (c) means for blocking all inbound connections or connection requests to the residential automation computer system over the data network; (d) means for initiating a secure connection by the residential automation computer system with the central system controller over the data network; (e) means for accessing the central system controller by an authorized user on a remote computer; and (f) means for facilitating communications between the authorized user on the remote computer and the residential automation computer system via the central system controller and the secure connection.

It is a fifth aspect of the present invention to provide a method for operating a residential automation system that includes a central system controller server operatively coupled to a data network and a residential automation computer system, operatively coupled to the data network, where the residential automation computer system being associated with a residence and configured to handle one or more residential automation functions, the method including the steps of: (a) blocking all inbound connections to the residential automation computer system over the data network; (b) initiating by the residential automation computer system a secure connection with the central system controller; and (c) communicating residential automation system information between the central system controller and the residential automation computer system over the secure connection. In a more detailed embodiment, the step of initiating a secure connection with the central system controller includes the step of initiating by the residential automation computer system a maintained secure connection. In an even more detailed embodiment, the method also includes the step of periodically renegotiating the maintained secure connection.

In an alternate detailed embodiment of the fifth aspect of the present invention, the communicating step includes the step of utilizing encryption algorithms.

In another alternate detailed embodiment of the fifth aspect of the present invention, the communicating step includes the step of utilizing public/private key pair techniques.

In another alternate detailed embodiment of the fifth aspect of the present invention, the method also includes the step of accessing the central system controller by a remote computer over the data network, where the communicating step includes the step of communicating residential automation system information between the remote computer and the residential automation computer system via the central system controller. In a more detailed embodiment, the accessing step includes the step of authenticating a user of the remote computer as having authorized access to the residential automation system information. In an even more detailed embodiment, the method also includes the step of monitoring for unauthorized access to the central system controller. In another more detailed embodiment, the data network is the World-Wide-Web, the accessing step includes the steps of providing an accessing Web site by the central system controller and logging onto the accessing Web site by the remote computer, and the communication step includes the step of communicating residential automation system information between the remote computer and the residential automation computer system via the accessing Web site.

It is a sixth aspect of the present invention to provide a method for operating a residential automation system that includes a central system controller server operatively coupled to a data network and a residential automation computer system, operatively coupled to the data network, where the residential automation computer system is associated with a residence and configured to handle one or more residential automation functions. The method includes the steps of: (a) blocking all inbound connections to the residential automation computer system over the data network; (b) maintaining a secure connection between the residential automation system and the central system controller on the data network; and (c) communicating residential automation system information between the central system controller and the residential automation computer system over the maintained secure connection. In a more detailed embodiment, the method also includes the step of periodically renegotiating the maintained secure connection.

In an alternate detailed embodiment of the sixth aspect of the present invention, the communicating step includes the step of utilizing encryption algorithms. In a more detailed embodiment, the communicating step includes the step of utilizing public/private key pair techniques.

In another alternate detailed embodiment of the sixth aspect of the present invention, the method also includes the step of accessing the central system controller by a remote computer over the data network, where the communicating step includes the step of communicating residential automation system information between the remote computer and the residential automation computer system via the central system controller. In a more detailed embodiment, the accessing step includes the step of authenticating a user of the remote computer as having authorized access to the residential automation system information. In an even more detailed embodiment, the method also includes the step of monitoring for unauthorized access to the central system controller. In another more detailed embodiment, the data network is the World-Wide-Web, the accessing step includes the steps of providing an accessing Web site by the central system controller and logging onto the accessing Web site by the remote computer, and the communication step includes the step of communicating residential automation system information between the remote computer and the residential automation computer system via the accessing Web site.

It is a seventh aspect of the present invention to provide a method for communicating with a residential automation computer system with a remote computer over a data network, comprising the steps of: (a) accessing a central system controller by the remote computer over the data network; (b) communicating residential automation system information between the remote computer and the central system controller; (c) initiating by the residential automation computer system a secure connection on the data network between the residential automation computer system and the central system controller; and (d) communicating residential automation system information between the central system controller and the residential automation computer system over the secure connection between the central system controller and the residential automation computer system. In a more detailed embodiment, the method also includes the step of blocking all inbound connections to the residential automation computer system over the data network.

It is an eighth aspect of the present invention to provide a method for communicating with a residential automation computer system with a remote computer over a data network, comprising the steps of: (a) accessing a central system controller by the remote computer over the data network; (b) communicating residential automation system information between the remote computer and the central system controller; (c) maintaining a secure connection on the data network between the residential automation controller and the central system controller; and (d) communicating residential automation system information between the central system controller and the residential automation computer system over the secure connection between the central system controller and the residential automation computer system. In a more detailed embodiment, the method also includes the step of blocking all inbound connections to the residential automation computer system over the data network. In an even more detailed embodiment, the method also includes the step of periodically renegotiating the maintained secure connection.

### BRIEF DESCRIPTION OF THE DRAWINGS

FIG. 1 illustrates a network overview of a current industry standard for Web control of a home automation system;

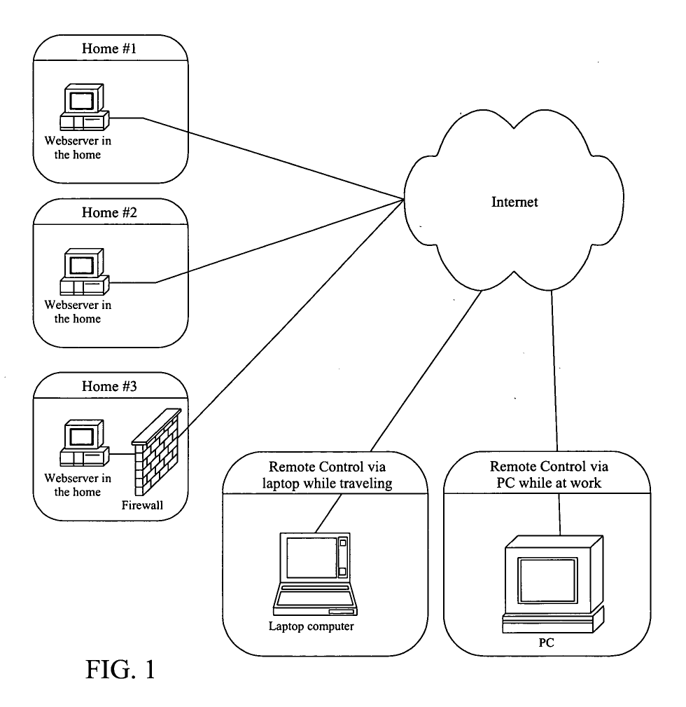

FIG. 2 provides a flow chart illustration indicating a prior-art authentication process for user connecting to their home Web server;

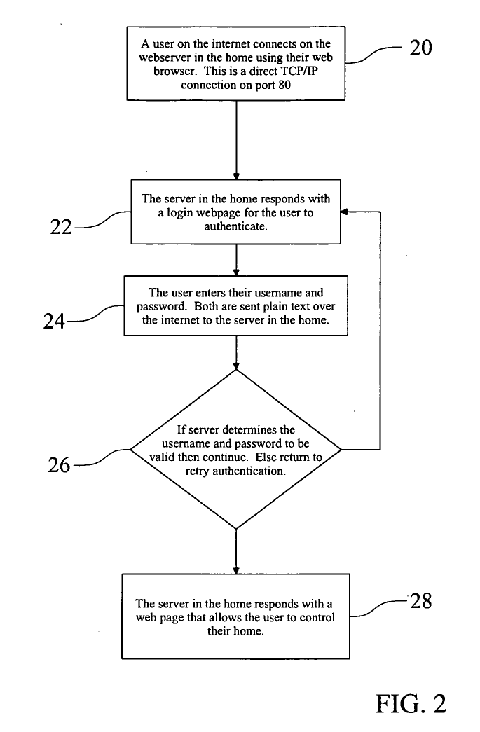

FIG. 3 illustrates a network overview of an exemplary embodiment of the present invention for providing Web control of a home or other type of residential automation system;

FIG. 4 provides a flow chart illustrating an exemplary authentication process that a residential server goes through when connecting to the central system controller's server farm; and

FIG. 5 illustrates a flow chart illustrating an exemplary authentication process that a remote user goes through when connecting with the central system controller's server farm.

### DETAILED DESCRIPTION

The present invention provides a computer network controlled/monitored automation system for a residence (such as a home, a business, an office, etc.) in which a residential server (located in or associated with the residence) controls and monitors security and other computer controllable systems within the residence. The residential server of the present invention is configured to deny any inbound connections or requests over the Internet (or over whatever alternative communication/data network that it is coupled to). Further, the residential server is configured to initiate a connection to a central system controller's server (or server farm) so that the residential server can receive commands and other communications from the central system controller's server, some of which may have been communicated to the central system controller's server by an authorized remote user/occupant of the residence over the Internet.

The “central system controller server” may be any type of computer or system of computers residing on the data network. As used with the exemplary embodiments of this invention, the central system controller server is capable of communicating data and commands over a connection with a residential automation computer system on the data network, and the central system controller server is capable of being accessed over the data network by a remote computer.

The “data network” referenced herein may be a local area network, a wide area network, a global network, the Internet, the World Wide Web, a wireless network, a cellular network, a satellite network, or any other communication system that enables two or more computers, computer systems and/or network devices to share and communicate information thereover.

The “residential automation computer system” referenced herein may be any type of computer or computer system or apparatus, which may or may not include peripheral devices or systems (such as an internal or external firewall), that is used to control various residential automation functions, as defined herein.

As used herein, a “residence” may be a home, an office, a business, a boat, or any other type of structure, system, or area monitored and/or controlled by an automation system.

The term “residential automation functions” used herein includes, but is not limited to, lighting, heating and cooling, home security, fire and smoke alarms, electrical, plumbing, kitchen appliances, television, multimedia, doors and windows, any other residential appliances, computer systems, manufacturing systems, or any other business systems, when controlled or monitored by a computer or computer system.

“Inbound data connection” refers to any connection over the data network in which data may be transmitted to or from a local computer or computer system, when the connection originates from an external computer or computer system on the data network; this term may also refer to a connection request from such an external computer or computer system to the local computer or computer system.

A “maintained secure connection” refers to a maintained connection on the data network between two computers or computer systems; it is not necessary that the connection is indefinitely maintained, only that it is maintained for two or more communications between the two computers; and, further, that the communications are protected by any available protection or encryption scheme or algorithm.

The term “server farm,” as used herein, refers to any collection of computers or computer systems, where each computer or computer system is capable of performing the same functions and incoming requests for a connection to a server are routed to a computer with available processing capacity.

“remote computer,” as discussed herein, may be any computer, computer system or network device that is or may be coupled to the data network to communicate with the central system controller's server.

An “authentication algorithm,” as discussed herein, may be any procedure or algorithm (or set of the same) by which a local computer or computer system verifies the identity of another computer or computer system that is attempting to establish a connection with the local computer.

A “firewall” is any device and/or software (or a collection of the same) that protects a computer or computer system coupled to a data network from unauthorized access to the computer or computer system over the data network. The firewall may reside within the computer or may be external to the computer or computer system.

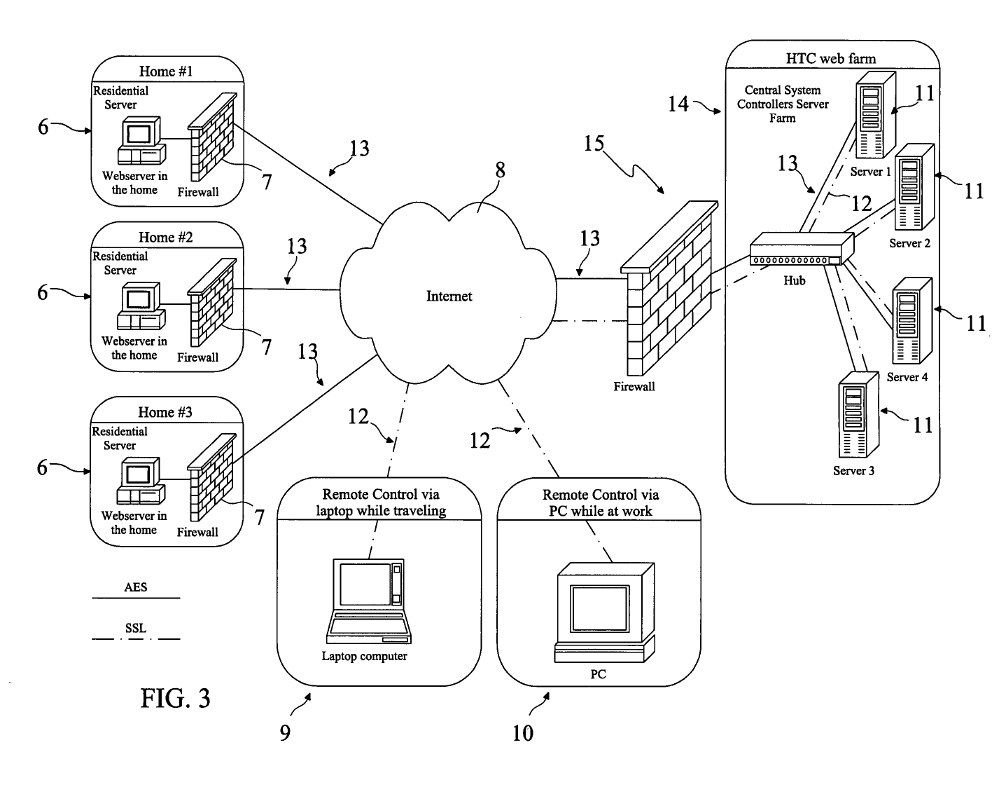

FIG. 3 illustrates a network overview of an exemplary embodiment of the present invention for providing Web control of a home or other type of residential automation system. As shown in FIG. 3, a residential automation computer system, such as residential server (HTC 7000 server) 6, includes a hardware firewall 7 that denies all communications requests from a data network such as the Internet 8. To access their residential servers, users on remote computers (via laptop 9 while traveling, or PC 10 while at work, for example) first connect to the central system controller's Web server 11 (in the HTC Web farm 14) over a secure Internet connection 12. The remote user will then communicate his or her commands, data or requests for his or her respective residential server 6 to the central system controller server 11 over this connection 12. Thereafter, the central system controller 11 will communicate such commands/data/requests to the respective residential server 6 over a secure connection 13 on the Internet 8 that has been or will be initiated by the residential server 6. In an exemplary embodiment, the secure connection 13 initiated by the residential server 6 utilizes AES encryption algorithms, where this secure connection 13 is maintained between the residential server 6 and the central system controller's Web server 11, allowing for periodic renegotiation if desired. Alternate embodiments have utilized 3DES-SHA1 encryption algorithms. Of course it is within the scope of invention to utilize any other suitable encryption or security algorithms available or known to those of ordinary skill in the art.

The central system controller's server farm 14 is protected with professional grade security hardware and software 15. The central system controller's server farm 14 is constantly monitored for intrusion attempts and prevents such hacks into the system from occurring. Larger systems may utilize multiple server farms distributed across the country to prevent denial of service attacks and increase fault tolerance. The communications between the residential server 6 and the central system controller's Web farm 14 utilize an encrypted protocol with the same level of protection as VPN but with modifications. Such modifications include the need to terminate the link at the application server and limit the data it can carry to only commands and data from the home automation system.

The present exemplary embodiment is extremely secure because it provides a single point of entry—through the central system controller's server farm 14—to the residential servers 6. Therefore, for hackers to access entry of the residential server, they must first hack through the central system controller's server farm 14. In the event of such an intrusion, the system can be immediately shut down. This will immediately protect all of the residences that the system is installed. With this approach, there is only one point of entry vulnerably to hack attempts. Therefore, rather than expecting homeowners to keep apprised of Internet security, the corporate security professionals watch over and maintain the system. In the event of a successful hack attempt, shutting down the server farm immediately protects all homes and gives the security teams time to effect repairs. If a hacker attempts to use trial and error techniques to gain access to the central system controller's server farm 14, such trial and error activities can be spotted immediately and halted. Large scale denial of service attacks can be limited by creating server farms regionally and allowing homes to connect to servers in other regions if the regional farm is unavailable.

As discussed above, in the exemplary embodiment, the residential servers 6 maintain a secure connection 13 with the central system controller's server 11 or server farm 14. The advantage with this aspect is that it has been found that the overhead for creating new secure links is greater than the overhead of maintaining a large number of idle links when the number of users to the system exceeds a predetermined point.

In the exemplary embodiment, communications between the residential servers 6 and the central system controller's server farm 14 utilize public/private key pair techniques (PKI). PKI is an acronym that stands for Public Key Infrastructure. It can describe a complete security philosophy and a discreet set of security processes. The exemplary embodiment of the present system uses PKI techniques to accomplish authentication. In PKI, the person/system that wants to receive secure data generates a public/private key pair. They can then distribute the public key to the world. Anyone can encrypt data with the public key but only the person who originally generated the key pair can read the message. Two parties can exchange public keys without the security risk that exchanging passwords poses. They can also authenticate the identity of the party since an imposter can send messages but would not be able to decipher the response. A simple hand shaking process ensures that both parties are listening and that they are who they say they are.

The residential server 6 of the present invention will use a public encryption key to encode a connection message out to the central system controller's server farm 14. The central system controller's server farm 14 will use its stored private key to decode the message. It would not be possible for a hacker to impersonate the central system controller's server farm and gain access to the home because they will not have the private key needed to complete the connection. The home will be able to authenticate the identity of the central system controller's server farm when it connects to the central system controller's server farm and the residential server will negotiate a pair of encryption keys. If the transmissions are intercepted or hijacked after the connection is complete, the hacker will not be able to decode any of the communications. Remote users (9,10) will log onto the home automation Web site provided by the central system controller web server 11 using HTTPs, which employs standard SSL encryption support by nearly all browsers. The system will then utilize commercial grade counter-measures to notify the IT staff of the central system controller's server 11 of intrusion attempts so that such attempts can be halted before they become a problem.

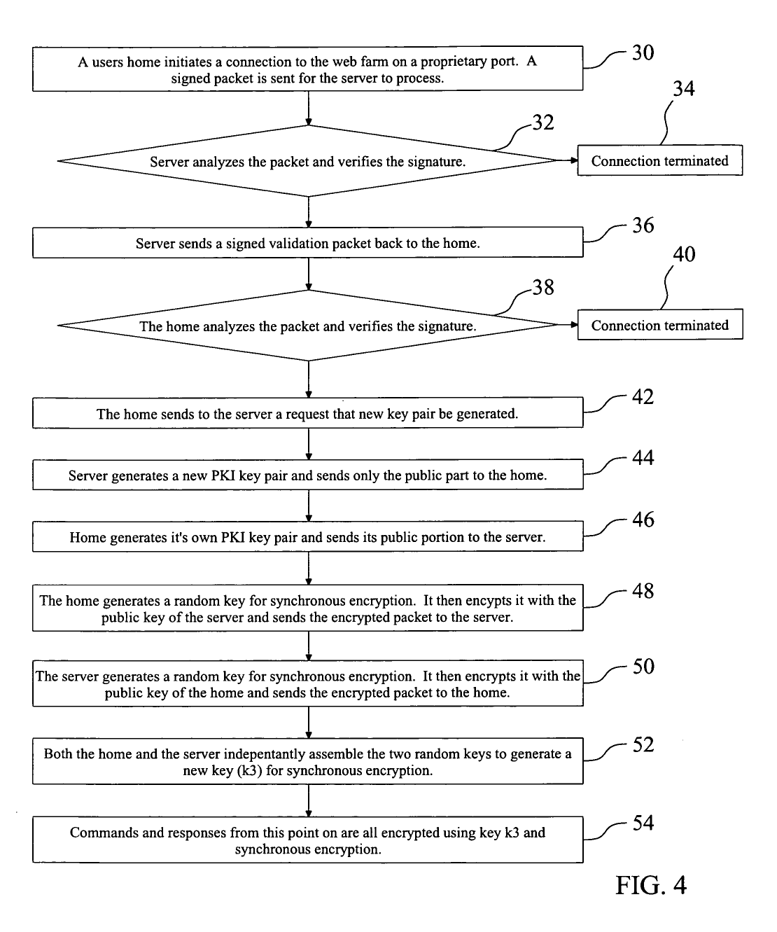

FIG. 4 provides a flow chart illustrating the authentication process that a residential server 6 goes through when connecting to the central system controller's server 11 or server farm 14. As shown in the first step 30, a residential server 6 will first initiate a connection 13 to the central system controller's server or server farm on a proprietary port. A signed packet is sent for the central system controller's server to process. In the next step 32, the central system controller's server farm analyzes the packet and verifies the signature. If the signature is not verified the connection is terminated in step 34. At step 32, network operations staff monitors and maintains the central system controller's server farm to prevent attacks against the servers themselves. The signature ensures that we are talking with a valid residential server. Upon verifying the signature, the method advances to the next step 36 in which the central system controller's server sends a signed validation packet back to the residential server. This step ensures that the home is talking to the central system controller's servers and not an imposter or a hacker. In the next step 38, the residential server analyzes the packet and verifies the signature. If the signature is not verified, the connection is terminated in step 40. Otherwise, the method advances to the next step 42 in which the residential server sends to the central system controller's Web farm a request that a new key pair be generated. Advancing to the next step 44, upon receiving this request, the central system controller's Web farm generates a new PKI key pair and sends only the public key to the residential server. In the next step 46, the residential server generates its own PKI key pair and sends its public key back to the central system controller's Web farm. In the next step 48, the residential server generates a random key for synchronous encryption. It then encrypts it with the public key of the central system controller's Web farm and sends the encrypted packet back to the central system controller's Web farm. In the next step 50, the central system controller's Web farm generates a random key for synchronous encryption. It then encrypts the random key with the public key of the residential server and sends the encrypted packet back to the residential server. In the next step 52, both the residential server and the central system controller's server independently assemble the two random keys to generate a new key (K3) for synchronous encryption.

The above steps illustrate a strong key exchange algorithm that generates two public/private key pairs that are then used to encrypt a new session key. This type of process guarantees that the key K3 is securely exchanged. In the last step 54, commands and responses between the residential server and the central system controller's Web farm are all encrypted using the K3 key in synchronous encryption. All data from the residential server is encrypted at this point. Every time the residential server reconnects, a new session key K3 will be generated. Currently, this encryption algorithm has not been hacked. It is highly unlikely that a hacker could capture the necessary data, to crack the encryption at all. In the event that a hacker could, the key would be useless because in the time it took to crack the encryption, the session would have renegotiated several times and several new K3s would have been generated.

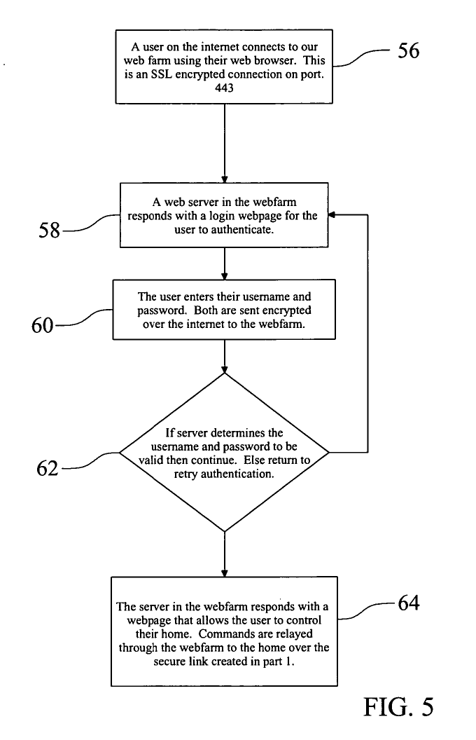

FIG. 5 illustrates a flow chart indicating the authentication process that a remote user (9, 10) goes through when connecting with the central system controller's server farm 14. In the first step 56, the remote user (9, 10) on the Internet connects to the central system controller's server farm over the Internet 8 using their Web browser. This is an SSL encrypted connection on port 443. At this point, the user may be a valid user or a hacker. Everybody on the public Internet can connect to the computer. This exposes the central system controller's server to many exploits. However, this is not a problem since the central system controller's server farm is maintained daily by network operations staff. All of the latest security patches are applied. Unusual traffic is investigated and potential hackers blocked at the investigation stage. In the next step 58, a Web server 11 in the central system controller's server farm 14 responds with a log-in Web page for the user to authenticate. In the next step 60, the user enters a user name and password. Both are sent encrypted over the Internet to the central system controller's server farm. The SSL encryption prevents hackers from capturing a user name and password. The SSL encryption is not available to typical home automation systems that are hosting Websites out of the user's home. In the next step 62, if the central system controller's server farm 14 determines the user name and password to be valid, then it continues on to the last step 64. Otherwise, the system returns to retry authentication in step 58. At this point, the hacker could use a brute force or dictionary attack. However, the central system controller's server farm actively monitors for these types of attacks and blocks the users after a few failed log-in attempts. In other words, dictionary and brute force attacks will be stopped. In the last step 64, a server 11 in the central system controller's server farm 14 responds with a Web page that allows the user to control and/or monitor their home. Commands are relayed from the central system controller's server farm 14 to the residential server 6 over the secure link 13 created in the process illustrated in FIG. 4. SSL encryption prevents hackers from intercepting useful data and prevents data from being rerouted or forged.

Thus, following from the above description and invention summaries, it should be apparent to those of ordinary skill in the art that, while the apparatuses and processes herein described constitute exemplary embodiments of the present invention, it is to be understood that the invention is not limited to these precise apparatuses and processes and that changes may be made therein without departing from the scope of the invention as defined by the claims. Additionally, it is to be understood that the invention is defined by the claims and it is not intended that any limitations or elements describing the exemplary embodiments set forth herein are to be incorporated into the meaning of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A computerized residential automation system comprising:
a central system controller server operatively coupled to a data network; and
a residential automation computer system, operatively coupled to the data network, the residential automation computer system being associated with a residence and configured to handle one or more residential automation functions;
the residential automation computer system being configured to deny all inbound data connections from the data network; and
the residential automation computer system being further configured to initiate a connection with the central system controller for communicating residential automation information between the central system controller and the residential automation computer system.

2. The computerized residential automation system of claim 1, wherein the connection with the central system controller is a secure connection.

3. The computerized residential automation system of claim 2, wherein the connection with the central system controller is a maintained secure connection.

4. The computerized residential automation system of claim 3, wherein the maintained secure connection is periodically renegotiated.

5. The computerized residential automation system of claim 2, wherein the secure connection utilizes encryption algorithms for communications between the residential automation computer system and the central system controller.

6. The computerized residential automation system of claim 2, wherein the secure connection utilizes public/private key pair techniques for communications between the residential automation computer system and the central system controller.

7. The computerized residential automation system of claim 1, wherein the central system controller includes a plurality of central system control computers in a server farm.

8. The computerized residential automation system of claim 1, wherein the central system controller includes a plurality of central system controller computers, each central system controller computer being associated with a specific geographic region.

9. The computerized residential automation system of claim 1, wherein the central system controller is configured to accept inbound connections from a remote computer operatively coupled to the data network.

10. The computerized residential automation system of claim 9, wherein the central system controller includes an authentication algorithm for controlling access to the central system controller to an authorized user of the remote computer.

11. The computerized residential automation system of claim 10, wherein the central system controller monitors for unauthorized access from the remote computer.

12. The computerized residential automation system of claim 1, wherein the data network is a global computer network.

13. The computerized residential automation system of claim 12, wherein the global computer network is the World-Wide-Web.

14. The computerized residential automation system of claim 13, wherein the central system controller provides an access Web site on the World-Wide-Web that is configured to accept Web access from a remote computer operatively coupled to the World-Wide-Web.

15. The computerized residential automation system of claim 14, wherein the access Web site is password protected for controlling access to the central system controller to authorized users.

16. The computerized residential automation system of claim 14, wherein the access Web site is configured to allow an authorized user of the remote computer to communicate with the residential automation computer system, wherein communications between the remote computer and the residential automation computer system are transferred over the connection initiated with the central system controller by the residential automation computer system.

17. The computerized residential automation system of claim 16, wherein the communications between the remote computer and the residential automation computer system are indirect communications that are processed by the central system server.

18. The computerized residential automation system of claim 1, further comprising a firewall operatively coupled between the data network and the residential automation computer system, the firewall preventing inbound data connections to the residential automation computer system from the data network.

19. The computerized residential automation system of claim 18, wherein the firewall is a hardware component separate from the residential automation computer system.

20. A computerized residential automation system comprising:
a central system controller server operatively coupled to a data network;
a residential automation computer system associated with a residence and configured to handle one or more residential automation functions; and
a firewall operatively coupling the residential automation computer system to the data network and being configured to deny all inbound data connections from the data network to the residential computer.

21. The computerized residential automation system of claim 20, wherein the residential automation computer system is further configured to initiate a connection with the central system controller over the data network for communicating residential automation information between the central system controller and the residential automation computer system.

22. The computerized residential automation system of claim 21, wherein the connection is a secure connection utilizing encryption algorithms for communications between the residential automation computer system and the central system controller.

23. The computerized residential automation system of claim 20, wherein communication between the residential automation computer system and the central system controller occurs over a maintained secure connection on the data network.

24. The computerized residential automation system of claim 23, wherein the maintained secure connection on the data network is initiated by at least one of the residential automation computer system and the firewall.

25. The computerized residential automation system of claim 23, wherein the maintained secure connection is periodically renegotiated.

26. The computerized residential automation system of claim 23, wherein the maintained secure connection utilizes encryption algorithms for communications between the residential automation computer system and the central system controller.

27. The computerized residential automation system of claim 20, wherein the central system controller includes a plurality of central system control computers in a server farm.

28. The computerized residential automation system of claim 20, wherein the central system controller includes a plurality of central system control computers, each central system control computer being associated with a specific geographic region.

29. The computerized residential automation system of claim 20, wherein the central system controller is configured to accept inbound connections from a remote computer operatively coupled to the data network.

30. The computerized residential automation system of claim 29, wherein the central system controller includes an authentication algorithm for controlling access to the central system controller to authorized users of the remote computer.

31. The computerized residential automation system of claim 30, wherein the central system controller monitors for unauthorized access from the remote computer.

32. The computerized residential automation system of claim 20, wherein the data network is a global computer network.

33. The computerized residential automation system of claim 32, wherein the global computer network is the World-Wide-Web.

34. The computerized residential automation system of claim 33, wherein the central system controller provides an access Web site on the World-Wide-Web that is configured to accept Web access from a remote computer operatively coupled to the World-Wide-Web.

35. The computerized residential automation system of claim 34, wherein the access Web site is password protected for controlling access to the central system controller to authorized users.

36. The computerized residential automation system of claim 34, wherein the access Web site is configured to allow an authorized user of the remote computer to communicate with the residential automation computer system, wherein communications between the remote computer and the residential automation computer system are transferred over a connection initiated with the central system controller by at least one of the residential automation computer system and the firewall.

37. The computerized residential automation system of claim 36, wherein the communications between the remote computer and the residential automation computer system are indirect communications that are processed by the central system server.

38. The computerized residential automation system of claim 34, wherein the access Web site is configured to allow an authorized user of the remote computer to communicate with the residential automation computer system, wherein communications between the remote computer and the residential automation computer system are transferred over a maintained connection between the central system controller and at least one of the residential automation computer system and the firewall.

39. A computerized residential automation system comprising:
a central system controller server operatively coupled to a data network; and
a residential automation computer system, operatively coupled to the data network, the residential automation computer system being associated with a residence and configured to handle one or more residential automation functions;
the residential automation computer system being configured to deny all inbound data connections from the data network; and
the residential automation computer system being connected with the central system controller over the data network by a maintained secure connection.

40. The computerized residential automation system of claim 39, wherein the maintained secure connection is initiated by the residential automation computer system.

41. The computerized residential automation system of claim 39, wherein the maintained secure connection is periodically renegotiated.

42. The computerized residential automation system of claim 39, wherein the central system controller is configured to accept inbound connections from a remote computer operatively coupled to the data network.

43. The computerized residential automation system of claim 42, wherein the central system controller includes an authentication algorithm for controlling access to the central system controller to authorized users of the remote computer.

44. The computerized residential automation system of claim 43, wherein the central system controller monitors for unauthorized access from the remote computer.

45. The computerized residential automation system of claim 43, wherein the data network is a global computer network.

46. The computerized residential automation system of claim 45, wherein the global computer network is the World-Wide-Web.

47. The computerized residential automation system of claim 46, wherein the central system controller provides an access Web site on the World-Wide-Web that is configured to accept Web access from a remote computer operatively coupled to the World-Wide-Web.

48. The computerized residential automation system of claim 47, wherein the access Web site is password protected for controlling access to the central system controller to authorized users.

49. The computerized residential automation system of claim 47, wherein the access Web site is configured to allow an authorized user of the remote computer to communicate with the residential automation computer system, wherein communications between the remote computer and the residential automation computer system are transferred over the maintained secure connection.

50. The computerized residential automation system of claim 49, wherein the communications between the remote computer and the residential automation computer system are indirect communications that are processed by the central system server.

51. A computerized residential automation system comprising:
a central system controller server operatively coupled to a data network;
a residential automation computer system, operatively coupled to the data network, the residential automation computer system being associated with a residence and configured to handle one or more residential automation functions;
means for blocking all inbound connections or connection requests to the residential automation computer system over the data network;
means for initiating a secure connection by the residential automation computer system with the central system controller over the data network;
means for accessing the central system controller by an authorized user on a remote computer; and
means for facilitating communications between the authorized user on the remote computer and the residential automation computer system via the central system controller and the secure connection.

52. A method for operating a residential automation system that includes a central system controller server operatively coupled to a data network and a residential automation computer system, operatively coupled to the data network, where the residential automation computer system being associated with a residence and configured to handle one or more residential automation functions, the method including the steps of:
blocking all inbound connections to the residential automation computer system over the data network;
initiating by the residential automation computer system a secure connection with the central system controller;
communicating residential automation system information between the central system controller and the residential automation computer system over the secure connection.

53. The method of claim 52, wherein the step of initiating a secure connection with the central system controller includes the step of initiating by the residential automation computer system a maintained secure connection.

54. The method of claim 53, further comprising the step of periodically renegotiating the maintained secure connection.

55. The method of claim 52, wherein the communicating step includes the step of utilizing encryption algorithms.

56. The method of claim 52, wherein the communicating step includes the step of utilizing public/private key pair techniques.

57. The method of claim 52, further comprising the step of accessing the central system controller by a remote computer over the data network, wherein the communicating step includes the step of communicating residential automation system information between the remote computer and the residential automation computer system via the central system controller.

58. The method of claim 57, wherein the accessing step includes the step of authenticating a user of the remote computer as having authorized access to the residential automation system information.

59. The method of claim 58, further comprising the step of monitoring for unauthorized access to the central system controller.

60. The method of claim 57, wherein:
the data network is the World-Wide-Web;
the accessing step includes the steps of providing an accessing Web site by the central system controller and logging onto the accessing Web site by the remote computer; and
the communication step includes the step of communicating residential automation system information between the remote computer and the residential automation computer system via the accessing Web site.

61. A method for operating a residential automation system that includes a central system controller server operatively coupled to a data network and a residential automation computer system, operatively coupled to the data network, where the residential automation computer system being associated with a residence and configured to handle one or more residential automation functions, the method including the steps of:
blocking all inbound connections to the residential automation computer system over the data network;
maintaining a secure connection between the residential automation system and the central system controller on the data network;
communicating residential automation system information between the central system controller and the residential automation computer system over the maintained secure connection.

62. The method of claim 61, further comprising the step of periodically renegotiating the maintained secure connection.

63. The method of claim 61, wherein the communicating step includes the step of utilizing encryption algorithms.

64. The method of claim 63, wherein the communicating step includes the step of utilizing public/private key pair techniques.

65. The method of claim 61, further comprising the step of accessing the central system controller by a remote computer over the data network, wherein the communicating step includes the step of communicating residential automation system information between the remote computer and the residential automation computer system via the central system controller.

66. The method of claim 65, wherein the accessing step includes the step of authenticating a user of the remote computer as having authorized access to the residential automation system information.

67. The method of claim 66, further comprising the step of monitoring for unauthorized access to the central system controller.

68. The method of claim 65, wherein:
the data network is the World-Wide-Web;
the accessing step includes the steps of providing an accessing Web site by the central system controller and logging onto the accessing Web site by the remote computer; and
the communication step includes the step of communicating residential automation system information between the remote computer and the residential automation computer system via the accessing Web site.

69. A method for communicating with a residential automation computer system with a remote computer over a data network, comprising the steps of:
accessing a central system controller by the remote computer over the data network;
communicating residential automation system information between the remote computer and the central system controller;
initiating by the residential automation computer system a secure connection on the data network between the residential automation computer system and the central system controller; and
communicating residential automation system information between the central system controller and the residential automation computer system over the secure connection between the central system controller and the residential automation computer system.

70. The method of claim 69, further comprising the step of blocking all inbound connections to the residential automation computer system over the data network.

71. A method for communicating with a residential automation computer system with a remote computer over a data network, comprising the steps of:
accessing a central system controller by the remote computer over the data network;
communicating residential automation system information between the remote computer and the central system controller;
maintaining a secure connection on the data network between the residential automation controller and the central system controller; and
communicating residential automation system information between the central system controller and the residential automation computer system over the secure connection between the central system controller and the residential automation computer system.

72. The method of claim 71, further comprising the step of blocking all inbound connections to the residential automation computer system over the data network.

73. The method of claim 72, further comprising the step of periodically renegotiating the maintained secure connection.
